(19) United States
(12) Patent Application Publication
(10) Pub. No.: US 2011/0295860 A1
(43) Pub. Date: Dec. 1, 2011

(54) Managing Drill-Through Parameter Mappings

(75) Inventors: David Dewar, Manotick (CA); Glenn D. Rasmussen, Ottawa (CA); Katherine A. Wallace, Ottawa (CA)

(73) Assignee: International Business Machines Corporation, Armonk, NY (US)

(21) Appl. No.: 13/034,786

(22) Filed: Feb. 25, 2011

(30) Foreign Application Priority Data
May 28, 2010 (CA) 2704676

(51) Int. Cl. G06F 17/30

(52) U.S. Cl. 707/748; 707/752; 707/E17.095

(57) ABSTRACT

A mechanism is provided for creating drill-through parameter mapping candidates. A location of source metadata and target metadata is received as well as a set of parameter mapping candidates. The source metadata, target metadata, and parameter mapping candidates are analyzed in order to form analyzed metadata. A set of parameter mapping candidates are then generated using the analyzed metadata, which are then prepared for presentation to an agent. A sorted set of parameter mapping candidates is then returned to the agent. In addition, a location of the source metadata and the target metadata as well as the set of parameter mapping candidates is sent to a parameter mapping creation process. A request is sent to retrieve a created parameter mapping candidate from the parameter mapping creation process. A parameter mapping candidate is then displayed to a user and a gesture of the user is acted upon.

### BACKGROUND

This disclosure relates generally to parameter mapping in a data processing system and more specifically to managing drill-through parameter mappings in a data processing system.

Reporting tools typically allow consumers to drill-through from a source report to a target report, using values determined from a selection in the source report to filter data in the target report. While this seems like a simple task, when one digs deeper the true complexity of the act of drilling-through becomes clearer.

The most challenging part of the drill-through operation is determining how data in the source context can he used to satisfy parameters in the target report. This task is known as parameter mapping. The drill-through behavior relies on a number of simple assumptions that are critical to delivering high-fidelity drill-through operations. Data source conformance presumes data sources used by drill-through sources and targets share a common taxonomy. The degree of commonality has a direct bearing on the number of meaningful drill-through paths since the paths should be based on the shared vocabulary of the data sources to have any value to consumers.

Conformance extends beyond the organization of data, for example, countries, accounts, and time to the actual data values in the data sources. For example, when an identifier code of CA identifies Canada in one data source a user assumes this fact is true in all data sources linked by a drill-through path using that categorization. The drill-through operation results in unexpected behavior when the value CA is also identified with Cape Verde or Cuba in one of the target data sources. The same data value is not required to exist in all data sources to deliver an effective drill-through solution, however consumer satisfaction is likely to be higher when a high percentage of the data values exist in all data sources.

To ensure the data returned in a drill target reflects the user's selection in the source context, drill-through paths should be based on keys instead of captions. While keys are by definition guaranteed to identify the data of interest, there is no such guarantee with a caption. Using a caption to perform a drill-through operation may result in more (or less) data being available in the drill target. For example, the information technology infrastructure may require a common set of key values across databases but allow applications to customize the caption data to suit their consumer base. Some databases may support multi-lingual applications, whereas other databases with common key sets may not. Runtime performance is also likely to suffer because resulting queries would typically filter on non-key or non-indexed columns.

While the use of keys is more likely to guarantee a successful drill-through implementation, the software should not prevent the use of non-key data to perform drill-through operations. However, a drill-through authoring environment should be biased to favor the use of key values when constructing drill-through definitions. Drill-through authoring is a process of determining how data in a source context can be used to satisfy parameters in a target report. The authoring process may also be known as parameter mapping.

A robust drill-through implementation typically requires significant time to author, or generate, the high number of required drill-through paths. In addition, a considerable amount of effort is typically required to author the drill-through targets to leverage parameters. A more effective means of authoring drill-through implementations is required.

### BRIEF SUMMARY

According to one embodiment, a computer-implemented process for creating drill-through parameter mapping candidates receives a location of source metadata, a location of target metadata and a set of parameter mapping candidates, analyzes source metadata, target metadata and received parameter mapping candidates to form analyzed metadata, generates a set of parameter mapping candidates using the analyzed metadata, prepares the set of generated parameter mapping candidates for presentation to an agent; and returns a sorted set of parameter mapping candidates to the agent. The computer-implemented process for creating drill-through parameter mapping candidates in another embodiment sends a location of source metadata, a location of target metadata and a set of parameter mapping candidates to a parameter mapping creation process and sends a request to retrieve a created parameter mapping candidate from the parameter mapping creation process. The computer-implemented process further displays a parameter mapping candidate to a user and acts upon a gesture of the user.

According to another embodiment, a computer program product for managing drill-through parameter mappings, comprises a computer recordable storage media containing computer executable program code stored thereon, the computer executable program code comprising, computer executable program code for receiving a location of source metadata, a location of target metadata and a set of parameter mapping candidates, computer executable program code for analyzing source metadata, target metadata and received parameter mapping candidates to form analyzed metadata, computer executable program code for generating a set of parameter mapping candidates using the analyzed metadata, computer executable program code for preparing the set of generated parameter mapping candidates for presentation to an agent and computer executable program code for returning a sorted set of parameter mapping candidates to the agent.

A computer program product for creating drill-through parameter mapping candidates comprises a computer recordable type storage media containing computer executable program code stored thereon. The computer executable program code comprises computer executable program code for sending a location of source metadata, a location of target metadata and a set of parameter mapping candidates to a parameter mapping creation process, computer executable program code for sending a request to retrieve a created parameter mapping candidate from the parameter mapping creation process, computer executable program code for displaying a parameter mapping candidate to a user and computer executable program code for acting on a gesture of the user.

According to another embodiment, an apparatus for managing drill-through parameter mappings comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a location of source metadata, a location of target metadata and a set of parameter mapping candidates, analyze source metadata, target metadata and received parameter mapping candidates to form analyzed metadata, generate a set of parameter mapping candidates using the analyzed metadata, prepare the set of generated parameter mapping candidates for presentation to an agent; and return a sorted set of parameter mapping candidates to the agent.

An apparatus for managing drill-through parameter mappings in another embodiment wherein a processor unit further executes the computer executable program code to direct the apparatus to send a location of source metadata, a location of target metadata and a set of parameter mapping candidates to a parameter mapping creation process, send a request to retrieve a created parameter mapping candidate from the parameter mapping creation process, display a parameter mapping candidate to a user and act on a gesture of the user.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system network operable for various embodiments of the disclosure;

FIG. 2 is a block diagram of an exemplary data processing system operable for various embodiments of the disclosure;

FIG. 3 is a block diagram of a parameter mapping system, in accordance with various embodiments of the disclosure;

FIG. 4 is a block diagram of components of the parameter mapping system of FIG. 3, in an example client server relationship, in accordance with various embodiments of the disclosure;

FIG. 5 is a block diagram of an online analytical processing (OLAP) to relational relationship using the parameter mapping system of FIG. 3, in accordance with one embodiment of the disclosure;

FIG. 6 is a tabular representation of an example set of parameters and capabilities that may be used with the parameter mapping system of FIG. 3, in accordance with one embodiment of the disclosure;

FIG. 7 is a block diagram of an example of a relational structure showing a foreign key to corresponding key column alternative relationship used with the parameter mapping system of FIG. 3, in accordance with one embodiment of the disclosure;

FIG. 8 is a block diagram of two hierarchies in a multidimensional structure using the parameter mapping system of FIG. 3, in accordance with one embodiment of the disclosure;

FIG. 9 is a flowchart of an overview of a parameter mapping candidate creation process using the parameter mapping system of FIG. 3, in accordance with one embodiment of the disclosure;

FIG. 10 is a flowchart of an overview of a parameter mapping candidate creation process using the parameter mapping system of FIG. 3, from a client perspective, in accordance with one embodiment of the disclosure; and

FIG. 11 is a flowchart of a process of applying heuristics plug-ins in the parameter mapping candidate creation process of FIG. 9, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Computer program code for carrying out operations of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

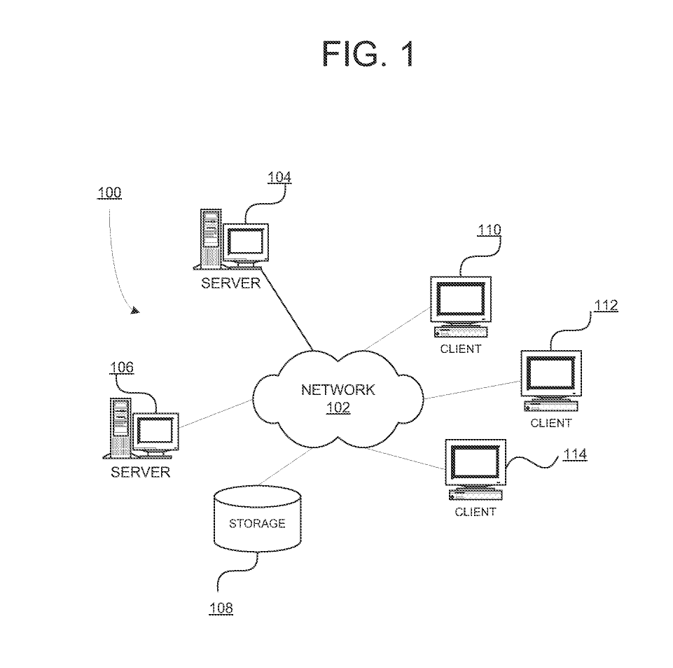

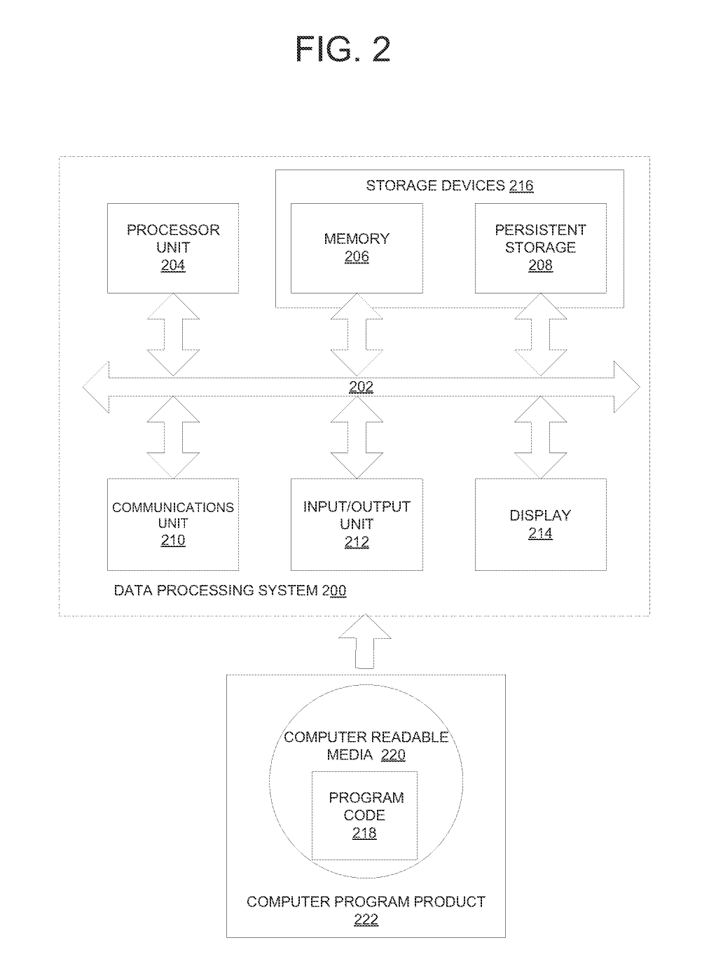

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Turning now to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

For example, illustrative embodiments typically operate in a web environment wherein software of the illustrative embodiments executes on a server machine and the user interacts with that software using a browser on a client machine. The server software in the example also generates the pages of a wizard or interactive assistant seen by the user.

Using data processing system 200 of FIG. 2 as an example a server such as server 104 and a client such as client 110, both of FIG. 1, may be implemented on representative systems either separately or on the same system. For example, according to one embodiment, a computer-implemented process for creating drill-through parameter mapping candidates is presented. Processor unit 204 of server 104 of network data processing system 100 of FIG. 1 receives a location of source metadata, a location of target metadata and a set of parameter mapping candidates, through network 102 of FIG. 1 using communications unit 210. Processor unit 204 analyzes source metadata, target metadata and received parameter mapping candidates to form analyzed metadata, generates a set of parameter mapping candidates using the analyzed metadata, prepares the set of generated parameter mapping candidates for presentation to an agent; and returns a sorted set of parameter mapping candidates to the agent.

Processor unit 204 on client 110 further sends a location of source metadata, a location of target metadata and a set of parameter mapping candidates to a parameter mapping creation process on server 104 of FIG. 1 and sends a request to retrieve a created parameter mapping candidate from the parameter mapping creation process on server 104 of FIG. 1. Processor 204 on client 110 of FIG. 1 further displays a parameter mapping candidate to a user using display 214 and acts upon a gesture of the user.

In another example, a computer-implemented process, using program code 218 stored in memory 206 or as a computer program product 222, for creating drill-through parameter mapping candidates comprises a computer recordable storage media, such as computer readable media 220, containing computer executable program code stored thereon. The computer executable program code comprises computer executable program code for creating drill-through parameter mapping candidates.

In an alternative embodiment, program code 218 containing the computer-implemented process may be stored within computer readable media 220 as computer program product 222. In another illustrative embodiment, the process for creating drill-through parameter mapping candidates may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process for creating drill-through parameter mapping candidates.

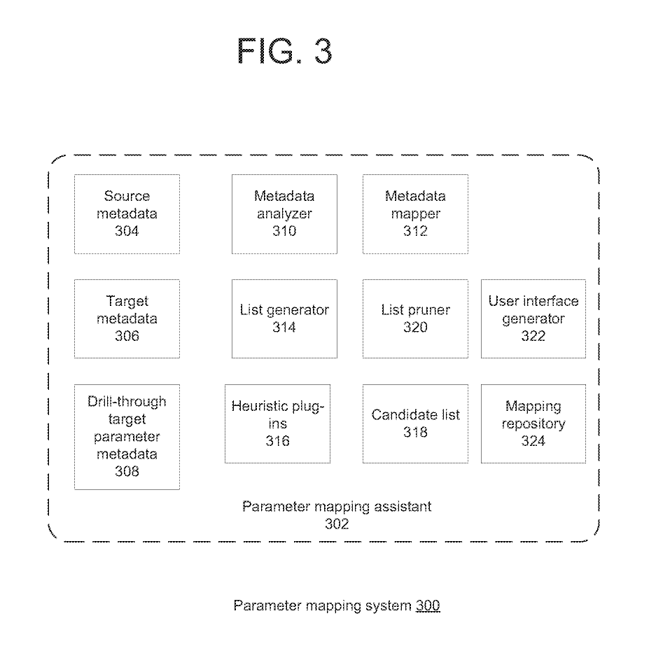

With reference to FIG. 3, a block diagram of a parameter mapping system, in accordance with various embodiments of the disclosure is presented. Parameter mapping system 300 is an example of an embodiment of a drill-though authoring system to assist users in creating and managing drill-through parameter mappings.

Parameter mapping system 300 comprises a number of components that may be implemented in hardware, software or a combination of hardware and software. Parameter mapping system 300 comprises a collection of components in the form of parameter mapping assistant 302. Parameter mapping assistant 302 further comprises components including source metadata 304, target metadata 306, drill-through target parameter metadata 308, metadata analyzer 310, metadata mapper 312, list generator 314, heuristics plug-ins 316, candidate list 318, list primer 320, user interface generator 322, and mapping repository 324. Other components supporting parameter mapping assistant 302 are not described but are typically found in a data processing system such as data processing system 200 of FIG. 2.

Constructing parameter mappings for drill-through operations requires knowledge of both the source domain, using source metadata 304 (the metadata model) and the target domain using target metadata 306 and drill-through target parameter metadata 308 (target report and metadata model). The models, and knowledge of the target report, can be used to deduce, using metadata analyzer 310, a set of candidate parameter mappings in the form of candidate list 318, for the set of source and target metadata that incorporate the best practices related to drill-through. Candidate list 318 is typically refined during the drill-through authoring process using list primer 320 to delete inappropriate members based on a user's previous selections. List pruner 320 may be a separate component as shown or integrated within other components such as list generator 314 or heuristic plug-ins 316 for example.

User interface generator 322 assists the user by constructing a set of interactive dialogs that operate in the browser of the user client environment. The browser content includes prompts to select generated parameter mappings and provisions to input user defined parameter mappings. Generated parameter mappings and user defined parameter mappings may be saved for later use in mapping repository 324. Mapping repository 324 may be any suitable storage mechanism for persisting and retrieval of parameter mappings, including a database or file in a file system.

Capabilities of the drill-through target must also be taken into consideration. The mappings provided by data mapper 312 form associations between a metadata item from a source and a parameter defined by a target. At runtime, the values for the source item need to be translated into a form that is acceptable to the parameter. But, the parameter could change and the mapping remains valid.

For example, consider a date parameter that accepts only a single value. Parameter mapping assistant 302 could pass a single date such as 2009-11-17. This works well for days, but not too well for months because 2009-11 is not a valid date value. In this case, the parameter requires an update to accept a range, to enable the passing of a range of values such as (2009-11-01->2009-11-30). In this case, though, the mapping is still valid and unchanged.

User interface generator 322 creates a user interface that assists the user with the construction of drill-through parameter mappings by providing advice that helps produce a more correct result than the user would typically achieve alone. Assistance includes pluggable heuristics 316 used with metadata analyzer 310 for determining candidate list 318 using source metadata items that could be assigned to the target parameters.

Parameter mapping assistant 302 of parameter mapping system 300 may be considered a server-based portion of a mapping assistant or authoring assistant. For example, the mapping assistant may be further presented in the form of a software wizard in a client browser designed to assist the drill-through author create parameter mappings quickly, easily, and without error. Parameter mapping assistant 302 makes effective use of source metadata 304, target metadata 306 and drill-through target parameter metadata 308 available. In addition, parameter mapping assistant 302 typically allows the user to create parameter mappings in addition to the parameter mappings suggested. The user always has the capability to work outside of parameter mapping assistant 302 to use facilities such as property sheets.

Parameter mapping system 300 therefore provides a user interface created by user interface generator 322 as a facade to promote the creation of effective parameter mappings used in drill paths. As such, parameter mapping assistant 302 is not meant to replace the more traditional property sheet usage that allows the author to construct an arbitrary parameter mapping. Of course the property sheet user interface allows much more latitude however without guidance from the software beyond basic edits.

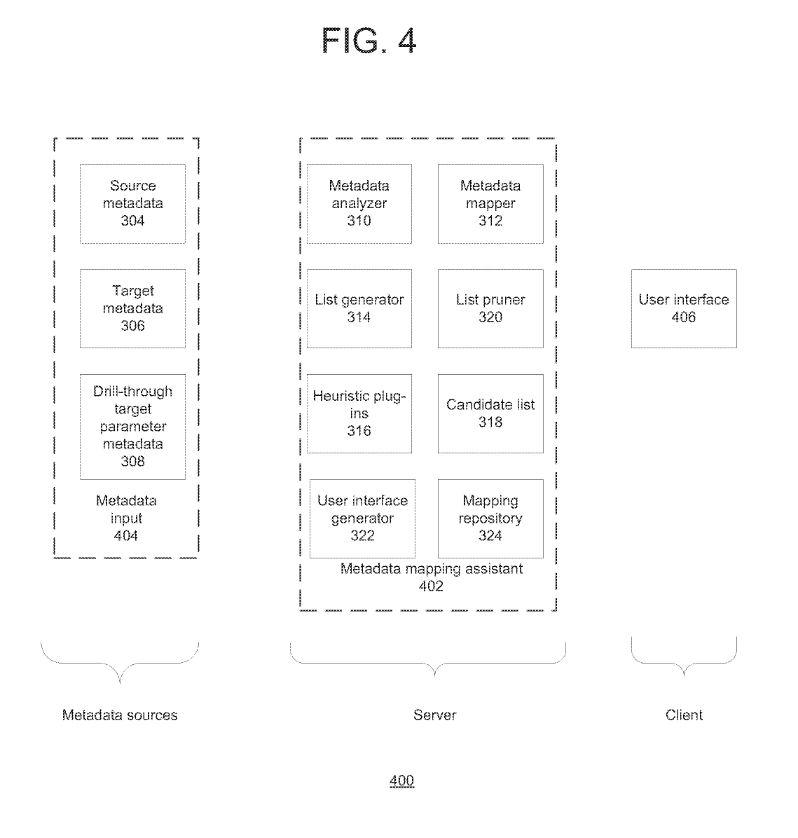

With reference to FIG. 4, a block diagram of components of parameter mapping system 300 of FIG. 3 is presented in accordance with various embodiments of the disclosure. Relationship 400 is an example of a relationship in which three segments representing metadata sources, server and client are depicted.

Metadata mapping assistant 402 corresponds to the bulk of the components of parameter mapping assistant 302 of FIG. 3. Metadata mapping assistant 402 provides a number of compute intensive services and is therefore typically located on a server class system. Metadata input 404 corresponds to the input used in parameter mapping assistant 302. User interface 406 represents a client portion and typically interfaces to the services of metadata mapping assistant 402 through a web environment browser component. A primary environment is a web environment wherein metadata mapping assistant 402 runs on a server machine and a user interacts with that software through user interface 406 using a browser on a client machine. The server software, such as user interface generator 322 of parameter mapping system 300 of FIG. 3, generates the pages of a wizard in graphical user interface 406 seen by the user.

To create drill-through paths, drill-through authors define parameter mappings between a drill-through source and a drill-through target. To create a parameter mapping successfully, a drill-through author considers issues including the data architecture of source report and target report data stores, data types of source metadata model items and target report parameters and type coercions and target report parameter capabilities such as support for value ranges or discrete values, support for single or multiple values, value exclusion, and whether a parameter is optional.

Different data architectures take different approaches to the organization of data. When defining a drill-through path, data architectures used in the source domain and target domain influence the parameter mappings. A simple parameter mapping between two data sources using the relational architecture assigns a value as specified from the source context to a parameter in the target. For example, assigning the value from the column [Countries].[CountryID] to the parameter ?Countries?. Perhaps the biggest challenge when performing drill-through operations between relational data sources occurs when the business keys used in the drill-through operation span multiple database columns. For example, a unique identifier for a State may be based on both the CountryID of the containing Country and a StateID. In this case, states from two different countries could share a common StateID value. In these situations, the data may not filter correctly leading to more data than expected being returned in the drill target. This situation can occur because the software does not correlate the values supplied to the parameters used to filter the country key and state key.

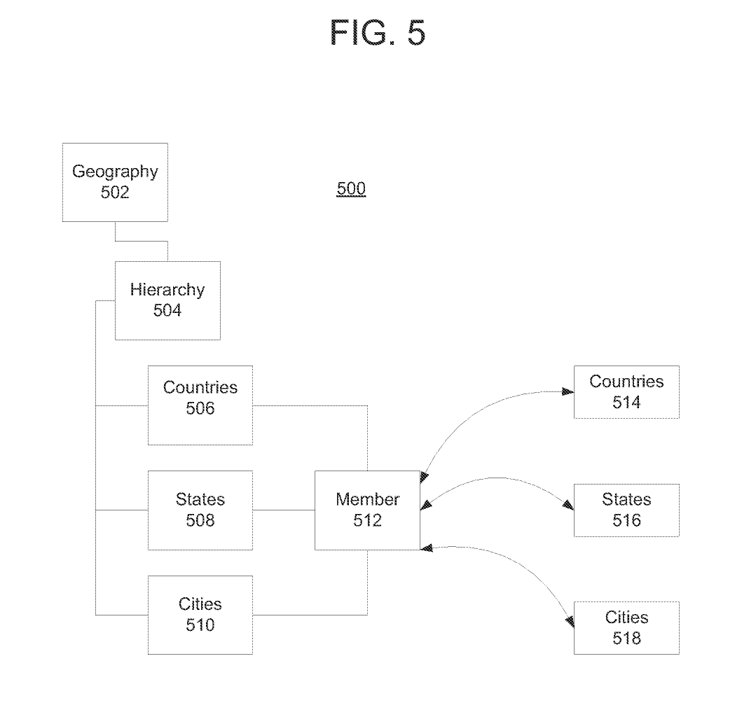

With reference to FIG. 5, a block diagram of an online analytical processing (OLAP) to relational drill-through relationship using the parameter mapping system of FIG. 3, in accordance with one embodiment of the disclosure is presented. Drill-through relationship 500 is an example of the challenges of parameter mapping between OLAP and relational architectures. The example depicts the parameter mapping that may need to occur between a member of a hierarchy in a dimension of an OLAP system and a key in a relational system. A member of the Geography dimension may be mapped to a row of one of the Countries, States or Cities tables, and the runtime system needs to figure this out, in part, based on the specification of the parameter mapping.

In an online analytical processing (OLAP) to relational drill-through example, the challenge is to coerce references to members in the multidimensional store (member unique names) to scalar values that can be used to perform filter operations in relational queries. Consider a simple dimension, Geography 502, consisting of a single hierarchy 504 with three levels of Countries 506, States 508 and Cities 510. The goal is to provide a drill-through to a target based on a relational architecture, using member 512 from any of the three levels in the Geography dimension. In this case, the target of Countries 514, States 516 and Cities 518 must define a parameter to accept the business key value corresponding to each level in the dimensional source.

Member 512 maybe from any of the three levels of hierarchy 504. As is the case with relational to relational drill-through, the software may not filter data correctly if multiple members are selected in the source because the software does not correlate the values supplied to the parameters used to filter the country key and state key as described in the previous example, which used a compound key.

Treatment of “special categories” such as My Favorite Places requires further consideration. The My Favorite Places member set may not be directly represented in the target data source. In this case, each member in the special category must be mapped independently to achieve a high-fidelity drill-through experience. When a special category is directly represented in the target data source, the special category can be treated like any other dimension member.

In a relational to online analytical processing drill-through conversion of a set of scalar business key values into a member reference, or member unique name is performed. The use of members is fundamental to the data architecture and is natural when using a multidimensional data source. Parameters in the target would typically be defined to use member references, known as member unique names.

To construct a member unique name for any member of the hierarchy, the software must use the business keys from the corresponding relational tables to traverse the member tree to locate the correct members in the target data source. Continuing to use the example with Geography 502, the process would search for member 512 in countries 506 with a business key value equivalent to the value from the key column of Countries 514 table. Further, a search for a child member in States 508 is performed with a business key value equivalent to the value from the key column of States 516 table. A search for a child member in Cities 510 uses a business key value equivalent to the value from the key column of Cities 518 table. The example uses the member unique name of the found member, member 512, to satisfy the parameter. An alternative process would create a “portable member unique name” using the business keys and defer the binding until the target is executed.

When creating model-based drill paths for relational to online analytical processing drill-through, a value from each corresponding table may not be available. This situation should be considered normal and the result of the mapping exercise may be a member in a non-leaf level, such as Countries 506 or States 508.

In a different example using similar data architectures, online analytical processing to online analytical processing drill-through involves passing member unique names from a source context to the target. Use of member unique names is natural when dealing with multidimensional data sources. Unlike the data values used in relational to relational drill-through, member unique names are typically complex data structures that are proprietary to the underlying data source implementation. Parameter mapping for a drill-through operation from a relational database implementation of one vendor to a relational database implementation of another vendor is relatively straightforward. The situation is much more complicated when drilling-through between different multidimensional data source implementations.

To handle drill-through operations, business keys from the source member must be used to locate the corresponding target member. The process is similar to that described earlier in the relational to online analytical processing scenario, In a similar fashion, the use of “portable member unique names” is typically considered as an alternative proposal.

In another example, different data types may be supported, for example data types of date, time, interval, MUN (member unique name), number and string. The MUN type is used exclusively with multidimensional data sources, whereas the other four types may be used with either relational or multidimensional data sources. The parameter mappings that contribute to drill-through paths must take the data types used in the source and target data sources into consideration, and the runtime system must provide a type coercion system enabling values from the source to be useful in the target.

Many of the type coercions are well known. For example, a number can be transformed into a string in a well-known, unambiguous manner. Data coercion, transformation, conversion or mapping may be performed within parameter mapping system 300 of FIG. 3. However, it is not possible to convert all strings into numbers (or dates, or other target types). In addition, many of the coercions between sub-types such as floating point and integer numbers are also well-known and may be considered during authoring of the drill-through paths and supported to facilitate the drill-through operations. Coercions to and from member unique names are more complicated requiring additional information for handling during the authoring process.

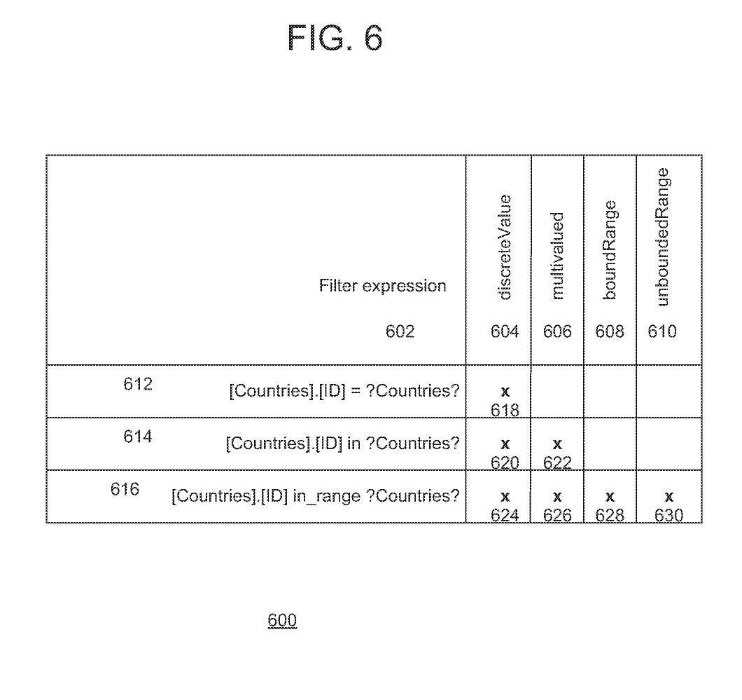

With reference to FIG. 6, a tabular representation of an example set of parameters and capabilities that may be used with the parameter mapping system of FIG. 3, in accordance with one embodiment of the disclosure, is presented. Table 600 is an example of a relationship between filter expressions and parameter capabilities using the Geography example of FIG. 5 with the parameter mapping system 300 of FIG. 3. The table illustrates that given a filter expression the software will determine the capabilities for the referenced parameter.

Filter expression 602 is a header for the column containing a set of filter expressions. Columns 604, 606, 608 and 610 correspond to an example of possible different parameter capabilities that may be used with parameter mapping system 300 of FIG 3. Four parameter capabilities are represented as discreteValue 604, multivalued 606, boundRange 608 and unboundedRange 610. Parameters and parameter capabilities exist independently of a drill-through; however drill-through implementation leverages these capabilities to solve specific problems.

The capabilities of a parameter are determined based on how the filter, such as filter expression 602, in which the parameter is defined is used. Various parameter capabilities may be used with parameter mapping system 300 of FIG. 3 including boundRange, defaultValueNotAcceptable, discreteValue, excludeValues, multivalued, optional, and unboundedRange. These capabilities are provided by the target and are used by a drill-through system to determine the types of parameter values that can be supplied for the parameters of the drill-through target. These capabilities exist independent of the drill-through system and may also used, for example, to auto-generate prompt pages.

The optional parameter capability is determined by the filter definition. The defaultValueNotAcceptable capability is determined by the underlying data source. The parameter capabilities of boundRange, discreteValue, multivalued, and unboundedRange are based on the filter expression. Table 600 presents some simple expressions and corresponding parameter capabilities. The model item [Countries].[ID] is assumed to be a simple scalar. For example, row 612 contains an expression of [Countries].[ID]=?Countries? with an indicator 618 signaling that the parameter ?Countries? would have the parameter capability discreteValue 604. In another example, row 614 contains an expression of [Countries].[ID] in ?Countries? with indicators 620 and 622 signaling that the parameter ?Countries? would have the parameter capabilities discreteValue 604 and multivalued 606. In a third example, row 616 contains an expression of [Countries].[ID] in_range ?Countries? with indicators 624, 626, 628 and 630 signaling that the parameter ?Countries? would have the parameter capabilities discrete Value 604, multivalued 606, boundRange 608 and unboundRange 610.

Choosing the right comparison operator is very important when defining filter expressions for use in drill-through scenarios. In most cases, the use of the equality operator (=) is to be discouraged in favor of the more flexible set operator “in”, since the “in” operator supports the drill-through operation when multiple values are selected in the source context.

When dealing with time values, an in_range operator may be favored, especially when drilling from online analytical processing to relational data sources. The main reason for this choice is that a time dimension member in a multidimensional data source represents a period of time. For example, performing a relational query that is equivalent to filtering a multidimensional source for a time in the OLAP domain by selecting the member 2009-11-01 (a day) would require the use of a filter expression equivalent to [Country].[Date].[Time] in_range {2009-11-01 T00:00:00 ->2009-11-30T23:59.59}.

The target parameters are defined during the creation of the target object. As such, the drill-through authoring experience must treat these parameter definitions as immutable. Of course, drill-through authors and the authors of drill-through targets can and should agree on the definitions of parameters early in the application design phase to avoid the additional rework of updating targets to support a rich drill-through experience.

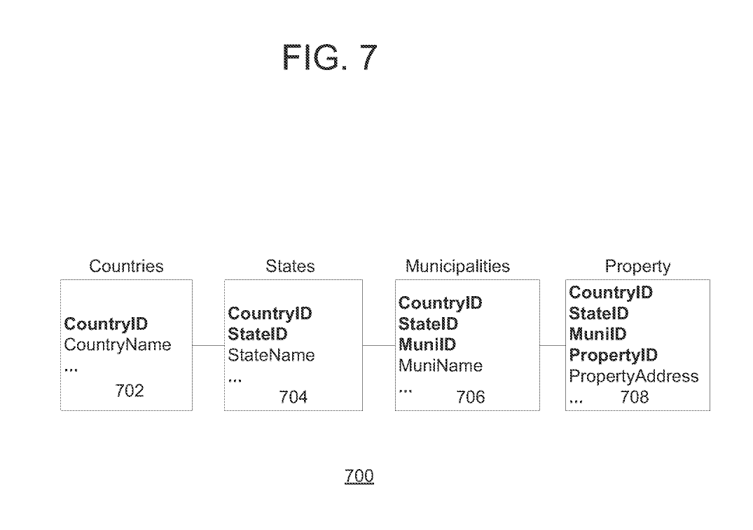

With reference to FIG. 7, a block diagram of an example of a relational structure showing a foreign key corresponding to a key column alternative relationship used with the parameter mapping system of FIG. 3, in accordance with one embodiment of the disclosure is presented. The treatment of corresponding alternate columns when defining drill-through parameter mappings is also considered in view of data architectures. When a determination is made that a source metadata item could be mapped to a key column the process would also map that source item to each of the foreign key columns as well. Situations involving the use of alternate columns can occur with both relational and multidimensional data hierarchies. For example in a relational architecture a column that is used as a foreign key is an alternative representation column for the corresponding key column. In relational structure 700, four blocks are presented representing relational tables of Countries 702, States 704, Municipalities 706 and Property 708. Each block contains representative key columns.

Alternate representation columns for [Countries].[CountryID] found in Countries 702 in this construction are defined as three alternatives of [States].[CountryID] from States 704, [Municipalities].[CountryID] from Municipalities 706, and [Property].[CountryID] from Property 708. In a similar manner alternate representation columns for [States].[StateID] as found in States 704 are defined as [Municipalities].[StateID] from Municipalities 706, and [Property].[StateID] from Property 708. For [Municipalities].[MuniID] a defined alternative representation column is [Property].[MuniID] from Property 708.

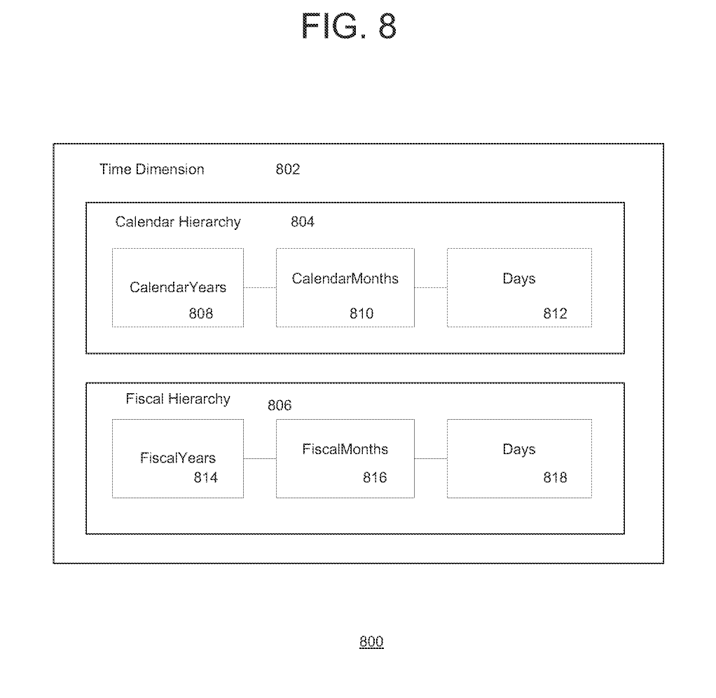

With reference to FIG. 8, a block diagram of two hierarchies in a multidimensional structure used with the parameter mapping system of FIG. 3, in accordance with one embodiment of the disclosure is presented.

When using multidimensional data architecture, as in multidimensional data representation 800, hierarchies defined in the same dimension can be considered alternative representations in many cases. For example, Time Dimension 802 may have hierarchies of Calendar Hierarchy 804 and Fiscal Hierarchy 806 representing calendar and fiscal years. Calendar Hierarchy 804 includes elements of CalendarYears 808, CalendarMonths 810 and Days 812. Fiscal Hierarchy 806 includes corresponding elements of FiscalYears 814, FiscalMonths 816 and Days 818.

Drill-through to a target using a member from either Calendar Hierarchy 804 or Fiscal Hierarchy 806 is possible independent of whether the target is dimensional or relational in nature. For relational targets, a typical mapping would convert the member to a date range. Alternative representations in this example construction are provided for [Time].[Calendar].[Days] as [Time].[Fiscal].[Days] and for [Time].[Calendar] as [Time].[Fiscal]. Some levels in this construction do not have alternative representations.

Handling of alternative representations is possible by defining parameter mappings that contain alternate source items and expressions. This approach allows the user to continue to constrain the use of the drill-through path based on an ability to provide a value for some parameter defined in the target. An alternate strategy allows multiple mappings for a single parameter. While multiple mappings for a single parameter would provide the same semantics in terms of parameter binding, this strategy would not allow the use of the drill-through path to be constrained as simply as the previous approach. Multiple mappings for a single parameter reduce the control over the result because additional focus is needed to determine which mapping is in effect.

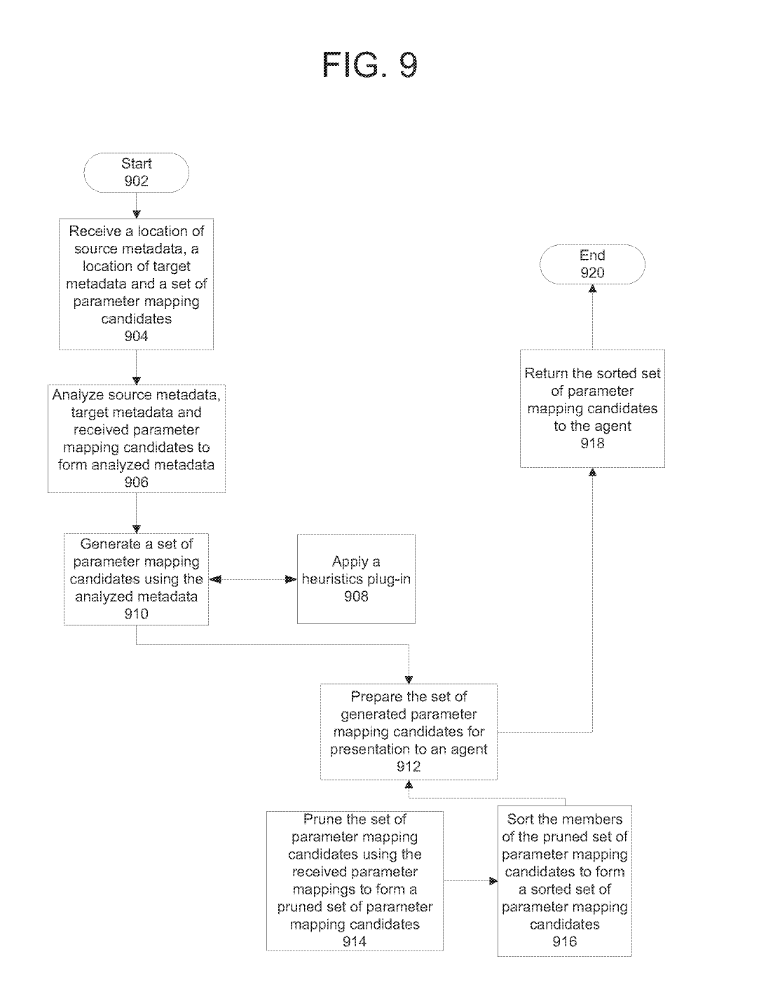

With reference to FIG. 9, a flowchart of a parameter mapping candidate creation process using the parameter mapping system of FIG. 3, in accordance with one embodiment of the disclosure is presented. Process 900 is an example of a parameter mapping process using parameter mapping assistant 302 of parameter mapping system 300 of FIG. 3.

Process 900 begins (step 902) and receives a location of source metadata, a location of target metadata and a set of parameter mapping candidates (step 904). Process 900 has access to a considerable amount of metadata during the initialization phase. This metadata consists of the source metadata model and the drill-through target. The drill-through target can provide the target metadata as well as the target parameter metadata. To provide a generic drill-through authoring experience metadata is obtained from any drill-through target. Access to the target parameter metadata, along with the source and target metadata models enables process 900 to determine the data architectures involved in the drill-through authoring session. This information is used to determine the appropriate mapping strategy and candidates for each parameter from the drill-through target. Input metadata may be cached to provide processing efficiencies.

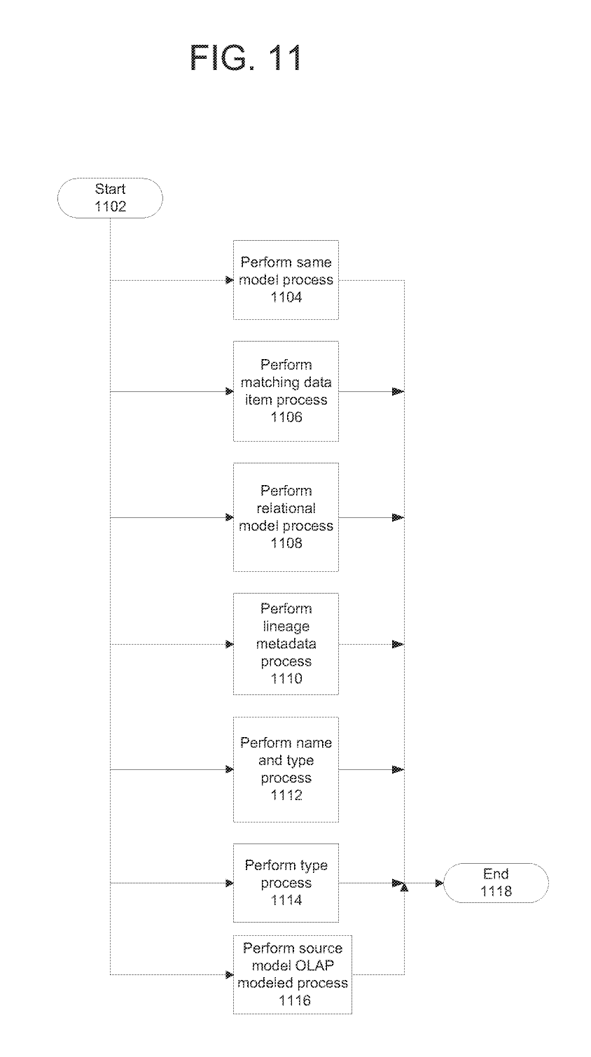

Process 900 analyzes source metadata, target metadata and received parameter mapping candidates to form analyzed metadata (step 906). Current parameter mapping metadata is provided in the form of saved parameter mappings typically from a prior iteration, process or saved drill-path that is being revised. Process 900 applies heuristics plug-ins, (step 908) such as heuristics plug-ins 316 of parameter mapping assistant 302 of FIG. 3. Heuristic plug-ins are applied, as appropriate, based on the metadata being processed as further described in the example of FIG. 11. The use of particular heuristics is determined by the metadata being processed, enabling the use of heuristics plug-ins to be metadata driven. For example, when a mapping is desired between two similar relational constructs a heuristic suited to online analysis processing would not process the data. A heuristic plug-in, from a set of heuristic plug-ins, is used in the data analysis portion of the process. The value of the plug-in concept is that new plug-ins can be added without having to change the invoking logic. The invoking logic does not have any a priori knowledge of particular plug-ins. The invoking logic will call each plug-in in the available set, and the plug-in will create candidates if it can, based on the current state, such as metadata architectures. Each created candidate parameter mapping has a score, (rank) which is then used to order the candidates.

The set of heuristic plug-ins comprises one or more heuristic plug-ins. The heuristic plug-ins are atomic in that each plug-in may be separately used and managed as needed. Selectable plug-ins provides the flexibility needed to allow the use of the proper plug-in at the proper time to process the specific type of data required. Plug-ins enables a capability to provide an extensible solution to meet the changing needs of the metadata environment.

For example, a reasonable implementation strategy would implement the resource intensive tasks of process 900 on a server-side, rather than performing these tasks in a browser environment. In particular, server-side tasks are performed by the drill-through service in response to web service requests from a client-side user interface component such as the user interface created by user interface generator 322 of parameter mapping assistant 302 of FIG. 3.

Process 900 generates a set of parameter mapping candidates using the analyzed metadata (step 910). Heuristic plug-ins are also applied, as appropriate, based on the metadata being processed during the generation of the set of parameter mapping candidates. Each candidate mapping in the set of parameter mapping candidates is assigned a score, or rank, when it is created. Process 900 prepares the generated set of parameter mapping candidates for presentation to an agent (step 912). Preparation performed in step 912 enables process 900 to prune the set of parameter mapping candidates using the received parameter mappings to form a pruned set of parameter mapping candidates (step 914). Process 900 applies pruning criteria that may be derived from previous metadata analysis operations and assigned ranking. Process 900 sorts the members of the pruned set of parameter mapping candidates to form a sorted set of parameter mapping candidates (step 916). Candidates in the list are parameter mappings for each parameter defined by the target metadata. The candidate parameter mappings are placed in a “best” first order using assigned rankings. Process 900 returns the sorted set of parameter mapping candidates to the agent (step 918) and terminates thereafter (step 920).

The agent may be a user or a programmatic entity. These parameter mappings, that have been ranked and sorted, are presented to the agent ordered by their rank with best matches presented first. Mappings are ranked on a scale from 1 to 100, with a rank of 100 being the best match, and a rank of 1 being the worst. Mappings are assigned a value based on the heuristic used to propose the candidate. A linear scale is typically the simplest for users to understand, but a logarithmic scale can also be used. For example, presentation steps may be provided through a graphical user interface wizard capability to manage interaction with a user form of an agent. A client drives the wizard by collecting user selections, handling operations such as, save, accept, and cancel, as well as an action to trigger another round of server-side processing (normally including a different set of initial mappings).

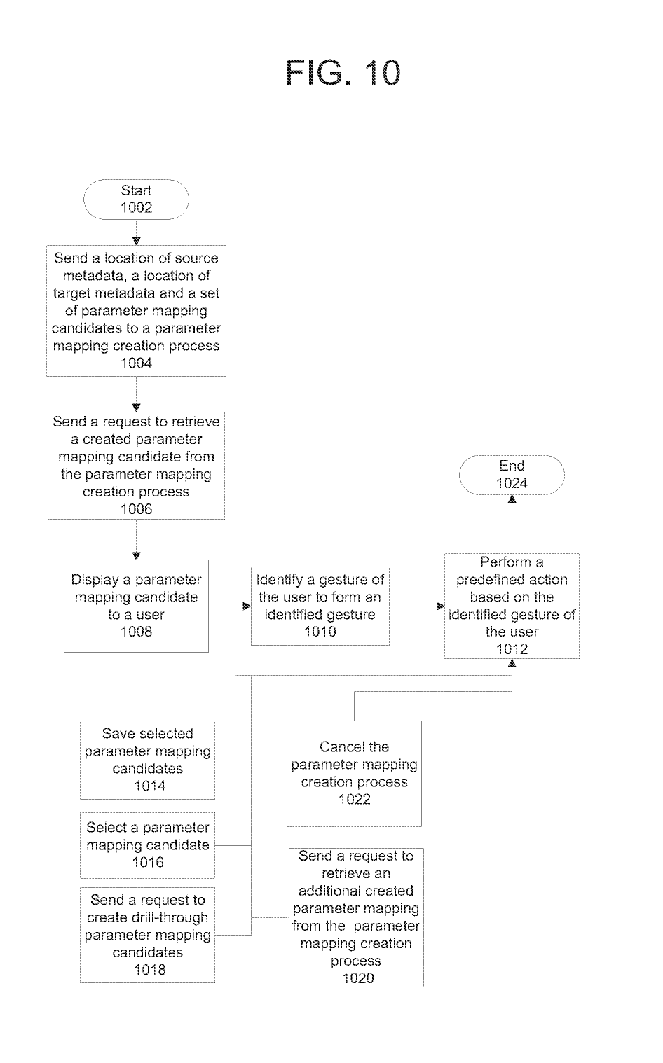

With reference to FIG. 10, a flowchart of a parameter mapping candidate creation process using the parameter mapping system of FIG. 3, from a client perspective in accordance with one embodiment of the disclosure is presented. Process 1000 is an example of a parameter mapping candidate creation process using a client perspective.

Process 1000 begins (step 1002) and sends a location of source metadata, a location of target metadata and a set of parameter mapping candidates to a parameter mapping candidate creation process (step 1004). Process 1000 sends a request to retrieve a created parameter mapping candidate from the parameter mapping creation process (step 1006).

Process 1000 displays a parameter mapping candidate to a user (step 1008). Process 1000 identifies a gesture of the user to form an identified gesture (step 1010). Process 1000 performs a predefined action based on the identified gesture of the user (step 1012), and terminates thereafter (step 1024). Process 1000 acts on the Identified gesture of the user by performing an action dependent upon the gesture of the user.

The predefined action of step 1012 may be selected from a set of predefined actions. The predefined action may require process 1000 to perform one of save selected parameter mapping candidates (step 1014), select a parameter mapping candidate (step 1016), send a request to create drill-though parameter mapping candidates (step 1018), send a request to retrieve an additional created parameter mapping from the parameter mapping creation process (step 1020) and cancel the parameter mapping creation process (step 1022).

Although the example provides a prompt and response interaction with a user the process may be performed equally well without a user and user interface. For example, the process may be performed programmatically to produce a set of parameter mappings that are simply saved and later retrieved for execution. The process may then function as a tool to create parameter mappings programmatically without user intervention according to the logic provided in the heuristic plug-ins.

With reference to FIG. 11, a flowchart of a process of applying heuristic plug-ins used in the parameter mapping candidate creation process of FIG. 9, in accordance with one embodiment of the disclosure is presented. Process 1100 is an example of using heuristics plug-ins 316 of parameter mapping assistant 302 of FIG. 3.

Although examples of specific heuristics are shown in the diagram, the framework has no knowledge of the specific heuristics. FIG. 11 illustrates an embodiment of a parallel progression through all of the heuristics. An alternative embodiment would process the specific heuristics in a linear progression. A controlling process iterates over the set of heuristics to obtain candidates because the framework knows nothing of the specific heuristics.

The example includes all ‘known’ heuristics with a capability for addition of ‘other’ heuristics as well. Other heuristics enable the system to be extensible. Other heuristics in this sense just infers the heuristic is not defined, but the heuristic conforms to the standard heuristic application-programming interface.

Process 1100 starts (step 1102) and Iterates through each heuristic. A same model optimization is processed (step 1104). Same model optimization in one scenario provides drill-through supported navigation from a source in one application, package or model to a target in another application. A simpler form of drill-through supports navigation between a source and a target that are in the same application. When this situation occurs, the assistant should simply select a method of useValueExpression for each parameter as the candidate source for the mapping. These candidates should be given the highest possible ranking of “100”.

To expedite the user experience, a further search for other candidates should not occur until requested by the user. In this case, the search would occur in a next round. The initial list of candidate is typically acceptable to the user.

Process 1100 performs a matching data item process (step 1106). The matching data item process attempts to match data items (or expressions) based on finding data items in the source model that unwind to the same physical data item as determined by a method of useValueExpression for the parameter.

Process 1100 performs a relational model process (step 1108). For example, a relational model process would take the candidates from matching data item process 1106 and find equivalent items in the source context. The relational model process would apply only if the source model had relationally modeled components. In this process many key columns are cloned and used in tables to provide foreign key constraints. For example, States 704 table of FIG. 7 may contain a column to identify a containing country. The relational model process will find these alternates and propose them as candidates, with a lower ranking than direct matches. A similar process can be provided for multidimensional sources as well.

Process 1100 performs a lineage metadata process (step 1110). The lineage metadata process takes advantage of lineage metadata to determine if physical data items can be related. For example, a column in an online analytic processing database may be related to a column in a star schema database (dimensionally modeled) by tracing through the lineage metadata. Lineage metadata may be provided in the form of a property attribute through previous data mapping exercises.

Process 1100 performs name and type comparison process (step 1112). The name and type comparison locates candidate items by performing comparisons using a combination of name and type. The combination provides a low quality match that typically returns a low ranking relative to other methods used.

Process 1100 performs a type comparison process (step 1114). The type comparison process locates candidates by type alone. This process may return so many candidates that the result may not be useful because of too many possible candidates.

Process 1100 performs source model OLAP modeled process (step 1116). The source model OLAP modeled process enables support of online analytic processing for members of a multidimensional data store.

In the example, other heuristics, which are simply not defined, represent additional heuristics processing capabilities using the extensible framework of heuristics plug-ins. Because each heuristics determines whether action is required and what action to perform the overall control is modular and adaptive to the set of heuristics available. Implementation of the heuristics is on a server side of a client server relationship and would not be exposed to clients. Process 1100 terminates (step 1118).

Heuristics plug-ins 316 of parameter mapping assistant 302 of FIG. 3 are designed to be implemented in a server-side component and are not visible to the client software. For example, the processes just described using heuristics plug-ins 316 enable addition of new heuristics and removal of unwanted heuristics from a deployed set at any time. Parameter mapping assistant 302 of FIG. 3 does not have compatibility requirements related to the heuristics. The constraints are related to the objects created by drill-through manager 302. The heuristics plug-ins presented in the example of the illustrative embodiment provide a general approach of using multiple plug-ins in a set of heuristics plug-ins. The parallel approach of FIG. 11 is only one possible implementation. Other implementations may include cascading plug-ins as an alternative or in addition to the example shown.

Thus an illustrative embodiment of a computer-implemented process for creating drill-through parameter mapping candidates receives a location of source metadata, a location of target metadata and a set of parameter mapping candidates, analyzes source metadata, target metadata and received parameter mapping candidates to form analyzed metadata, generates a set of parameter mapping candidates using the analyzed metadata, prepares the set of generated parameter mapping candidates for presentation to an agent; and returns a sorted set of parameter mapping candidates to the agent.

The computer-implemented process for creating drill-through parameter mapping candidates in another embodiment sends a location of source metadata, a location of target metadata and a set of parameter mapping candidates to a parameter mapping creation process and sends a request to retrieve a created parameter mapping candidate from the parameter mapping creation process, The computer-implemented process further displays a parameter mapping candidate to a user and acts upon a gesture of the user.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type storage media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for creating drill-through parameter mapping candidates, the method comprising:
receiving a location of source metadata, a location, of target metadata and a set of parameter mapping candidates;
analyzing source metadata, target metadata and parameter mapping candidates to form analyzed metadata;
generating a set of parameter mapping candidates using the analyzed metadata;
preparing the set of parameter mapping candidates for presentation to an agent; and
returning a sorted set of parameter mapping candidates to the agent.

2. The method of claim 1, wherein receiving the location of source metadata, the location of target metadata and the set of parameter mapping candidates is performed in response to the agent:
sending the location of source metadata, the location of target metadata and the set of parameter mapping candidates to a parameter mapping creation process; and
sending a request to retrieve a created parameter mapping candidate from the parameter mapping creation process; and
wherein, responsive to the agent receiving the sorted set of parameter mapping candidates, the agent:
displays the sorted set of parameter mapping candidates to a user; and
acts on a gesture of the user.

3. The method of claim 2, wherein acting on the gesture of the user farther comprises one of:
cancelling the parameter mapping creation process;
selecting at least one parameter mapping candidate;
saving selected parameter mapping candidates;
sending a request to retrieve an additional created parameter mapping candidate from the parameter mapping creation process; and
sending a request to create drill-through parameter mapping candidates based on the selected parameter mapping candidates.

4. The method of claim 1, wherein preparing the set of parameter mapping candidates for presentation to the agent further comprises:
pruning the set of parameter mapping candidates using current parameter mapping metadata and assigned scores to form a pruned set of parameter mapping candidates; and
sorting members of the pruned set of parameter mapping candidates to form the sorted set of parameter mapping candidates.

5. The method of claim 1, wherein generating the set of parameter mapping candidates using the analyzed metadata further comprises:
processing the analyzed metadata using a heuristic plug-in.

6. The method of claim 1, wherein returning the sorted set of parameter mapping candidates to the agent further comprises:
sending a subset of candidates requested by the agent.

7. The method of claim 5, wherein the heuristic plug-in is from a set comprising:
a same model heuristic, a matching data heuristic, a source model relationally modeled component heuristic, a source model OLAP modeled component heuristic, a lineage metadata heuristic, a name and type comparison heuristic, and a type heuristic.

8. A computer program product for creating drill-through parameter mapping candidates, the computer program product comprising:
a computer recordable type storage media containing computer executable program code stored thereon, the computer executable program code comprising:
computer executable program code for receiving a location of source metadata, a location of target metadata and a set of parameter mapping candidates;
computer executable program code for analyzing source metadata, target metadata and parameter mapping candidates to form analyzed metadata;
computer executable program code for generating a set of parameter mapping candidates using the analyzed metadata;
computer executable program code for preparing the set of parameter mapping candidates for presentation to an agent; and
computer executable program code for returning a sorted set of parameter mapping candidates to the agent.

9. The computer program product of claim 8, wherein the computer executable program code for receiving the location of source metadata, the location of target metadata and the set of parameter mapping candidates is performed in response to the agent performing computer executable program code for:
sending the location of source metadata, the location of target metadata and the set of parameter mapping candidates to a parameter mapping creation process; and
sending a request to retrieve a created parameter mapping candidate from the parameter mapping creation process; and
wherein, responsive to the agent receiving the sorted set of parameter mapping candidates, the agent further performing computer executable program code for:
displaying the parameter mapping candidate to a user; and
acting on a gesture of the user.

10. The computer program product of claim 9, wherein the computer executable program code for acting on the gesture of the user further comprises one of:
computer executable program code for cancelling the parameter mapping creation process;
computer executable program code for selecting at least one parameter mapping candidate;
computer executable program code for saving selected parameter mapping candidates;
computer executable program code for sending a request to retrieve an additional created parameter mapping candidate from the parameter mapping creation process; and
computer executable program code for sending a request to create drill-through parameter mapping candidates based on the selected parameter mapping candidates.

11. The computer program product of claim 8, wherein the computer executable program code for preparing the set of parameter mapping candidates for presentation to the agent further comprises:
computer executable program code for pruning the set of parameter mapping candidates using current parameter mapping metadata and assigned scores to form a pruned set of parameter mapping candidates; and
computer executable program code for sorting members of the pruned set of parameter mapping candidates to form the sorted set of parameter mapping candidates.

12. The computer program product of claim 8, wherein the computer executable program code for generating the set of parameter mapping candidates using the analyzed metadata further comprises:
computer executable program code for processing the analyzed metadata using a heuristic plug-in.

13. The computer program product of claim 8, wherein the computer executable program code for returning the sorted set of parameter mapping candidates to the agent further comprises:
computer executable program code for sending a subset of candidates requested by the agent.

14. The computer program product of claim 12, wherein the computer executable program code for the heuristic plug-in is from a set comprising:
computer executable program code for a same model heuristic, computer executable program code for a matching data heuristic, computer executable program code for a source model relationally modeled component heuristic, computer executable program code for a source model OLAP modeled component heuristic, computer executable program code for a lineage metadata heuristic, computer executable program code for a name and type comparison heuristic, and computer executable program code for a type heuristic.

15. An apparatus for creating drill-through parameter mapping candidates, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive a location of source metadata, a location of target metadata, and a set of parameter mapping candidates;
analyze source metadata, target metadata and parameter mapping candidates to form analyzed metadata;
generate a set of parameter mapping candidates using the analyzed metadata;
prepare the set of parameter mapping candidates for presentation to an agent; and
return a sorted set of parameter mapping candidates to the agent.

16. The apparatus of claim 15, wherein receiving the location of source metadata, the location of target metadata and the set of parameter mapping candidates is performed in response to the agent:
sending the location of source metadata, the location of target metadata and the set of parameter mapping candidates to a parameter mapping creation process; and
sending a request to retrieve a created parameter mapping candidate from the parameter mapping creation process; and
wherein, responsive to the agent receiving the sorted set of parameter mapping candidates, the agent executes computer executable program code to direct the agent to:
displays the sorted set of parameter mapping candidates to a user; and
acts on a gesture of the user.

17. The apparatus of claim 16, wherein the agent executing the computer executable program code to act on the gesture of the user further directs the agent to execute computer executable code to perform one of:
cancel the parameter mapping creation process;
select at least one parameter mapping candidate;
save selected parameter mapping candidates;
send a request to retrieve an additional created parameter mapping candidate from the parameter mapping creation process; and
send a request to create drill-through parameter mapping candidates based on the selected parameter mapping candidates.

18. The apparatus of claim 15, wherein the processor unit executes the computer executable program code to prepare the set of parameter mapping candidates for presentation to the agent further directs the apparatus to:
prune the set of parameter mapping candidates using current parameter mapping metadata and assigned scores to form a pruned set of parameter mapping candidates; and
sort members of the pruned set of parameter mapping candidates to form the sorted set of parameter mapping candidates.

19. The apparatus of claim 15, wherein the processor unit executes the computer executable program code to generate the set of parameter mapping candidates using the analyzed metadata further directs the apparatus to:
process the analyzed metadata using a heuristic plug-in, wherein the heuristic plug-in is one of; a same model heuristic, a matching data heuristic, a source model relationally modeled component heuristic, a source model OLAP modeled component heuristic, a lineage metadata heuristic, a name and type comparison heuristic, and a type heuristic.

20. The apparatus of claim 15, wherein the processor unit executes the computer executable program code to return the sorted set of parameter mapping candidates to the agent further directs the apparatus to:
send a subset of candidates requested by the agent.
